(19) United States
(12) Patent Application Publication
(10) Pub. No.: US 2009/0098454 A1
(43) Pub. Date: Apr. 16, 2009

(54) SPHERICAL ELECTROLYTIC MANGANESE DIOXIDE AND ALKALINE PRIMARY BATTERY USING THE SAME

(76) Inventors: Harunari Shimamura, Osaka (JP); Jun Nunome, Kyoto (JP); Fumio Kato, Osaka (JP)

Correspondence Address: MCDERMOTT WILL & EMERY LLP, 600 13TH STREET, NW, WASHINGTON, DC, 20005-3096, US

(21) Appl. No.: 12/244,331

(22) Filed: Oct. 2, 2008

(30) Foreign Application Priority Data
Oct. 10, 2007 (JP) 2007-264378

(51) Int. Cl. H01M 2/02; H01M 2/00; C01G 45/02; C25D 1/00

(52) U.S. Cl. 429/164; 429/163; 423/605; 428/402; 205/74

(57) ABSTRACT

An object is to provide an electrolytic manganese dioxide with optimized properties, and a high capacity alkaline primary battery with excellent high-rate discharge characteristics. Disclosed is a spherical electrolytic manganese dioxide having an average circularity of 0.89 or more. The loss on heating from 200 to 400° C. of the spherical electrolytic manganese dioxide is preferably 2.5% by weight or more. Also disclosed is an alkaline primary battery including the above-described spherical electrolytic manganese dioxide as a positive electrode active material.

### FIELD OF THE INVENTION

The present invention relates to alkaline primary batteries and more particularly to improvements to positive electrode active material included in an alkaline primary battery.

### BACKGROUND OF THE INVENTION

Alkaline primary batteries include a positive electrode case also serving as a positive electrode terminal, a cylindrical pellet of positive electrode material mixture disposed in close contact with the inner wall of the positive electrode case, a gelled zinc negative electrode disposed in the inside of the pellet of positive electrode material mixture, and a separator interposed between the pellet of positive electrode material mixture and the zinc negative electrode. The positive electrode material mixture of alkaline primary batteries includes a positive electrode active material containing manganese dioxide, and a conductive agent. The conductive agent is exemplified by graphite. Such alkaline primary batteries have an inside-out structure.

With widespread use of digital equipment in recent years, the load power of equipment for which alkaline primary batteries are used has been gradually increased. Under these circumstances, batteries having excellent high-rate discharge characteristics and an excellent discharge capacity have been demanded. To meet such a demand, various proposals have been made for improvements to the manganese dioxide contained in the positive electrode active material.

Manganese dioxide is generally synthesized by electrolysis, chemical synthesis, and the like.

Japanese Laid-Open Patent Publication No. 2004-186127 discloses synthesizing manganese dioxide by electrolysis and collecting electrolytic manganese dioxide (EMD) in a state of slurry from an anode plate.

As an example of chemical synthesis, there is a method in which manganese carbonate is subjected to air oxidation, followed by acid treatment and treatment for “heavying”, namely, for increasing its bulk density (see Battery Handbook, 3rd Ed., edited by the Battery Handbook Editing Committee, pp. 68-69).

Improvement in the capacity of batteries can be achieved, for example, by means of improving the filling property of the manganese dioxide. In order to improve the filling property, it is effective to form manganese dioxide particles into a suitable shape, and particularly, it is preferable to form the particles into a spherical shape.

However, in the case of electrolysis, it is difficult to form spherical electrolytic manganese dioxide since the particles are deposited on an electrode plate. Japanese Laid-Open Patent Publication No. 2004-186127 discloses that the electrolytic manganese dioxide adhered to an anode plate is removed as a slurry by washing the anode plate with hot water. In other words, the electrolytic manganese dioxide is collected from the anode plate by wet crushing. Crushed electrolytic manganese dioxide includes a particle (amorphous in shape) on the order of micrometer, the particle being an aggregate of crystallites on the order of nanometer (e.g., needle-like crystallites). It is considered, therefore, that the electrolytic manganese dioxide particles disclosed in Japanese Laid-Open Patent Publication No. 2004-186127 are amorphous in shape and low in circularity. This would result in poor filling property of the manganese dioxide with respect to a battery case, and therefore it would be difficult to further improve the battery capacity.

In contrast, in the case of chemical synthesis in which chemical manganese dioxide (CMD) is synthesized using manganese carbonate as a starting material, the shape of manganese carbonate is maintained in the synthesized manganese dioxide. For this reason, by using approximately spherical manganese carbonate as a starting material, the shape of the particles of the obtained CMD will approximate to a spherical shape. The CMD thus obtained has an average circularity of, for example, 0.94 to 0.96. It is considered, therefore, that the CMD has excellent filling property in view of the shape.

However, since the CMD contains little combined water, there is almost no manganese deficiency. Because of this, the diffusion of hydrogen ions in the interior of manganese dioxide is inhibited, resulting in deteriorated high-rate discharge characteristics of batteries.

### BRIEF SUMMARY OF THE INVENTION

In order to solve the foregoing problems, an object of the present invention is to provide a spherical electrolytic manganese dioxide and a method for producing the same, and a high capacity alkaline primary battery with excellent high-rate discharge characteristics (particularly a small alkaline primary battery such as an AA size alkaline primary battery).

A first aspect according to the present invention relates to a spherical electrolytic manganese dioxide having an average circularity of 0.89 or more.

The loss on heating from 200 to 400° C. of the spherical electrolytic manganese dioxide is preferably 2.5% by weight or more.

The weight loss rate of electrolytic manganese dioxide when heated in the temperature range of 200 to 400° C. (i.e., loss on heating from 200 to 400° C.) is proportional to the amount of combined water contained in the manganese dioxide. The loss on heating from 200 to 400° C. is closely related to battery characteristics. Specifically, the larger the value is, the more the battery characteristics can be improved.

In the spherical electrolytic manganese dioxide, the total volume of particles having a particle size of 1 μm or more is preferably 40% or more relative to the entire volume.

Such a spherical electrolytic manganese dioxide as described above allows hydrogen ions to diffuse well through the solid phase thereof and has an excellent filling property into the positive electrode, and therefore the high-rate discharge characteristics and the battery capacity are improved.

A second aspect according to the present invention relates to an alkaline primary battery including: a positive electrode including a positive electrode active material; a negative electrode; a separator interposed between the negative electrode and the positive electrode; an electrolyte; and a case having a space for housing the positive electrode, the negative electrode, the separator, and the electrolyte, wherein the positive electrode active material contains the spherical electrolytic manganese dioxide as described above.

The present invention relates to, for example, an alkaline primary battery in which, when a cycle comprising the steps of discharging for 2 seconds under a load of 1600 mW and then discharging for 10 seconds under a load of 650 mW is repeated without intervals between the cycles, the number of cycles repeated until the discharge voltage reaches 0.6 V is 360 cycles or more.

A third aspect according to the present invention relates to a method for producing the above-described spherical electrolytic manganese dioxide. The spherical electrolytic manganese dioxide is produced by any one of the production methods (1) to (3) as described below.

(1) A method for producing a spherical electrolytic manganese dioxide comprising:

a deposition step of depositing manganese dioxide by electrolysis of a solution containing manganese; and

a sphericalization step of sphericalizing the manganese dioxide deposited in the deposition step, with the use of an impact-type sphericalization apparatus comprising: a cylindrical casing with a plurality of grooves formed on its inner peripheral surface; and an approximately cylindrical rotor with a plurality of grooves formed on its outer peripheral surface, the rotor being mounted rotatably around an axis thereof coinciding with an axis of the casing, wherein subject particles to be processed introduced into the bottom of the casing are guided into a processing portion formed between the inner peripheral surface of the casing and the outer peripheral surface of the rotor, by means of a vortex flow generated between the rotor and the casing by the rotation of the rotor; and the subject particles are sphericalized by the collisions of the subject particles against the inner peripheral surface of the casing and the outer peripheral surface of the rotor and the collisions of the subject particles with each other, while passing through the processing portion before being discharged from the top of the casing.

(2) A method for producing a spherical electrolytic manganese dioxide comprising:

a deposition step of depositing manganese dioxide by electrolysis of a solution containing manganese; and

a sphericalization step of sphericalizing the manganese dioxide deposited in the deposition step, with the use of an impact-type sphericalization apparatus comprising: a cylindrical outside container arranged such that a center axis thereof is along the vertical direction; a disc-shaped dispersion rotor mounted horizontally rotatably, vertically below the outside container; and an inside drum disposed in the outside container so as to be spaced apart from the inner wall surface of the outside container and from the dispersion rotor, wherein subject particles to be processed are introduced upwardly into the space between the outside container and the inside drum and guided over the upper opening end of the inside drum, through the interior of the inside drum and to the lower opening end of the inside drum; and the subject particles are sphericalized by the collisions of the subject particles against the inner wall surface of the outside container, the collisions of the subject particles against the wall surfaces of a plurality of blocks provided so as to be spaced apart from one another on the peripheral upper surface of the dispersion rotor rotating horizontally, and the collisions of the subject particles with each other.

(3) A method for producing a spherical electrolytic manganese dioxide comprising:

a deposition step of depositing manganese dioxide by electrolysis of a solution containing manganese; and

a sphericalization step of sphericalizing the manganese dioxide deposited in the deposition step, with the use of a fluidized-bed jet mill comprising: a bottomed approximately cylindrical tank; and a plurality of jet nozzles for supplying compressed air into the tank, the jet nozzles being disposed at the side of the bottom of the tank so as to be directed to the center of the tank, wherein subject particles to be processed are sphericalized by the collisions of the subject particles with each other caused by a flow of the compressed air supplied from each of the jet nozzles.

According to the present invention, it is possible to provide a spherical electrolytic manganese dioxide and a high capacity alkaline primary battery with excellent high-rate discharge characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing an example of the impact-type sphericalization apparatus.

FIG. 2 is a longitudinal sectional view schematically showing another example of the impact-type sphericalization apparatus.

FIG. 3 is a longitudinal sectional view schematically showing an example of the fluidized-bed jet mill.

FIG. 4 is a partially sectioned front view of an alkaline primary battery according to the present invention.

### DETAILED DESCRIPTION OF THE INVENTION

The average circularity of the spherical electrolytic manganese dioxide of the present invention is 0.89 or more. The spherical electrolytic manganese dioxide having such a high average circularity exhibits an excellent filling property as a positive electrode active material. The use of this spherical electrolytic manganese dioxide, therefore, can provide a high capacity alkaline primary battery with excellent high-rate discharge characteristics.

The average circularity of the electrolytic manganese dioxide is 0.89 or more, and preferably 0.92 or more. When the average circularity is below 0.89, the surface area of manganese dioxide particles is increased and the space between adjacent manganese dioxide particles is enlarged, and therefore excessive gaps are formed in the positive electrode. This reduces the filling property of the manganese dioxide particles into the positive electrode, resulting in a reduction in the discharge capacity of the battery.

The average circularity of the electrolytic manganese dioxide can be measured by measuring the circularities of manganese dioxide particles first, and then calculating the average of the measured values.

The circularity is measured with a particle image analyzer. Specifically, the image of manganese dioxide particles is captured with the particle image analyzer first, and the projection area of one of the manganese dioxide particles is determined from the captured image. Next, the circumference length of a circle having the same area as that of the projection area thus determined (hereinafter referred to as an “equivalent circle”) is calculated. The circumference length of the equivalent circle is divided by the length of the contour of the manganese dioxide particle to determine a circularity.

In the manner as described above, the circularities of 2000 or more particles are measured to calculate the average of the measured circularities of these particles. The average thus determined is referred to as an average circularity of the electrolytic manganese dioxide. As the value of the average circularity approaches one, the shape of the manganese dioxide particles approximates to a sphere.

The average circularity of an electrolytic manganese dioxide can be adjusted by allowing the electrolytic manganese dioxide to be subjected to sphericalization.

For the sphericalization, for example, a ball mill as generally employed for sphericalization of particles may be used. In the sphericalization using a ball mill, firstly, water, balls of several millimeters in diameter, and a powder of electrolytic manganese dioxide are placed in a milling container having a cylindrical body. This milling container is rotated about a central axis of the body to perform sphericalization. Preferably, the central axis serving as a rotation axis is substantially orthogonal to the direction of gravity.

In the sphericalization using a ball mill as described above, however, too much load is applied to the particles. For example, when the particles subjected to the sphericalization are particles with high hardness such as alumina particles, the corners and edges of the particles are rounded off by the sphericalization using a ball mill, and thus the particles are easily sphericalized. However, in the case of electrolytic manganese dioxide composed of particles with comparatively low hardness, the particles tend to be broken by the load applied thereto during the sphericalization. For this reason, it has been difficult to sphericalize electrolytic manganese dioxide particles.

On the contrary, when any one selected from the processing apparatuses as described in (A), (B) and (C) below is used to perform sphericalization of electrolytic manganese dioxide under the below-described conditions of sphericalization for each apparatus, the sphericalization can be successfully performed while the load applied to the manganese dioxide particles is suppressed low. As a result, cracks of particles on the electrolytic manganese dioxide are prevented, and thus a spherical electrolytic manganese dioxide having an average circularity of 0.89 or more can be provided.

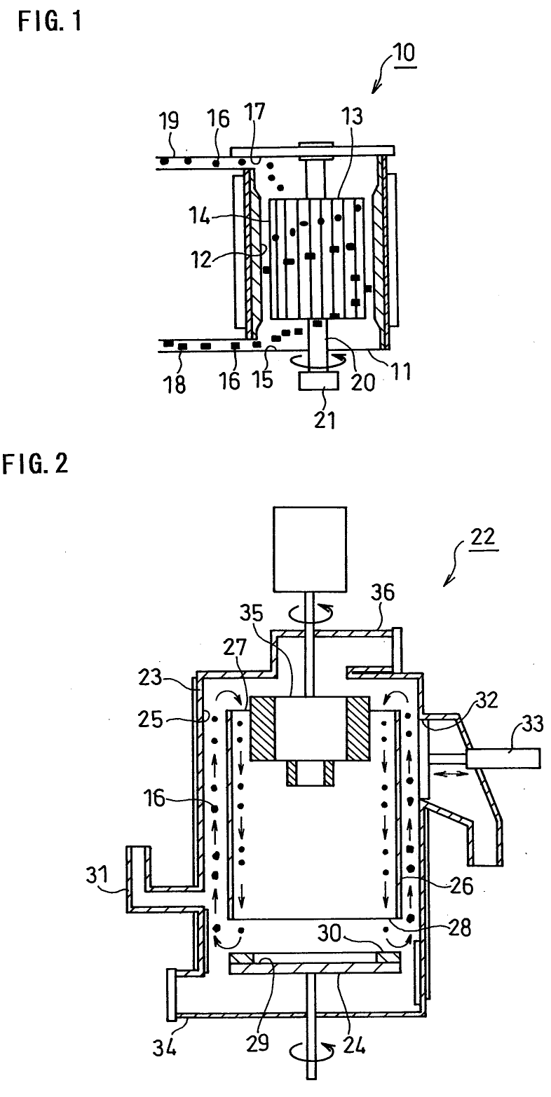

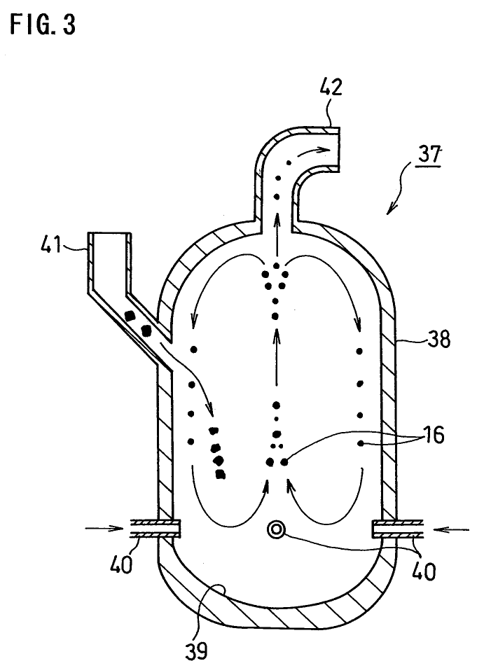

Examples of the apparatus for sphericalizing electrolytic manganese dioxide include an impact-type sphericalization apparatus 10 (as shown in FIG. 1) as described in (A) below, an impact-type sphericalization apparatus 22 (as shown in FIG. 2) as described in (B) below, and a fluidized-bed jet mill 37 (as shown in FIG. 3) as described in (C) below.

(A) An impact-type sphericalization apparatus 10 comprising: a cylindrical casing 11 with a plurality of grooves formed on an inner peripheral surface 12; and an approximately cylindrical rotor 13 with a plurality of grooves formed on an outer peripheral surface 14, the rotor being mounted rotatably around an axis thereof coinciding with an axis of the casing 11, wherein subject particles 16 to be processed introduced into a bottom 15 of the casing 11 are guided into a processing portion formed between the inner peripheral surface 12 of the casing 11 and the outer peripheral surface 14 of the rotor 13, by means of a vortex flow generated between the rotor 13 and the casing 11 by the rotation of the rotor 13; and the subject particles 16 are sphericalized by the collisions of the subject particles 16 against the inner peripheral surface 12 of the casing 11 and the outer peripheral surface 14 of the rotor 13 and the collisions of the subject particles 16 with each other, while passing through the processing portion before being discharged from a top 17 of the casing 11.

In the impact-type sphericalization apparatus 10 as shown in FIG. 1, the subject particles 16 are introduced into the casing 11 through an inlet 18 for introducing subject particles located at the side of the bottom 15 of the casing 11, and discharged externally from an outlet 19 for discharging subject particles located at the side of the top 17 of the casing 11. The rotor 13 is supported such that a rotation axis 20 thereof coincides with the axis of the casing 11. A motor 21 drives the rotor 13 to rotate in the casing 11 around the rotation axis 20.

(B) An impact-type sphericalization apparatus 22 comprising: a cylindrical outside container 23 arranged such that a center axis thereof is along the vertical direction; a disc-shaped dispersion rotor 24 mounted horizontally rotatably, vertically below the outside container; and an inside drum 26 disposed in the outside container 23 so as to be spaced apart from an inner wall surface 25 of the outside container 23 and from the dispersion rotor 24, wherein the subject particles 16 to be processed are introduced upwardly into the space between the outside container 23 and the inside drum 26 and guided over an upper opening end 27 of the inside drum 26, through the interior of the inside drum 26 and to a lower opening end 28 of the inside drum 26; and the subject particles 16 are sphericalized by the collisions of the subject particles 16 against the inner wall surface 25 of the outside container 23, the collisions of the subject particles 16 against the wall surfaces of a plurality of blocks 30 provided so as to be spaced apart from one another on a peripheral upper surface 29 of the dispersion rotor 24 rotating horizontally, and the collisions of the subject particles 16 with each other.

In the impact-type sphericalization apparatus 22 as shown in FIG. 2, the subject particles 16 are introduced into the outside container 23 through an inlet 31 for introducing subject particles. Upon completion of sphericalization, a discharge valve 33 is released and the subject particles 16 are discharged externally from a discharge outlet 32. Cooling air is introduced, as needed, from an inlet 34 for introducing cooling air into the impact-type sphericalization apparatus 22. Ultrafine powder produced from excessive crushing of the subject particles 16 during the sphericalization is classified by a classification rotor 35 and discharged from an exit 36 for discharging ultrafine powder.

(C) A fluidized-bed jet mill 37 comprising: a bottomed approximately cylindrical tank 38; and a plurality of jet nozzles 40 for supplying compressed air into the tank 38, the jet nozzles being disposed at the side of a bottom 39 of the tank 38 so as to be directed to the center of the tank 38, wherein the subject particles 16 to be processed are sphericalized by the collisions of the subject particles 16 with each other caused by a flow of the compressed air supplied from each of the jet nozzles 40.

In the fluidized-bed jet mill 37 as shown in FIG. 3, the subject particles 16 are introduced into the tank 38 from an inlet 41 for introducing subject particles provided on the peripheral surface of the tank 38. The sphericalized subject particles 16 are discharged from an outlet 42 for discharging subject particles in the upper part of the tank 38.

In the case of using the impact-type sphericalization apparatus as described in (A) above for sphericalization of electrolytic manganese dioxide, the conditions for sphericalizing electrolytic manganese dioxide are preferably that the feeding rate of the electrolytic manganese dioxide into the casing is 20 to 60 kg/h, the number of rotation of the rotor is 5,000 to 13,000 rpm, and the number of times of processing with the impact-type sphericalization apparatus is one to three times.

Further, in the forgoing range of the feeding rate of the electrolytic manganese dioxide into the casing, a range of 20 to 50 kg/h is particularly preferred, and 20 kg/h is more preferred. In the forgoing range of the number of rotation of the rotor, a range of 6,000 to 10,000 rpm is particularly preferred, and a range of 8,000 to 10,000 rpm is more preferred. In the forgoing range of the number of times of processing with the impact-type sphericalization apparatus, one or two times is particularly preferred.

In the processing portion of the impact-type sphericalization apparatus as describe in (A) above, the distance between the inner peripheral surface of the casing and the outer peripheral surface of the rotor is preferably 1 to 10 mm.

The impact-type sphericalization apparatus as describe in (A) above is specifically exemplified by a sphericalization system available from EARTH TECHNICA CO., LTD. under the trade name “Kryptron Orb” (model number CSH0), and the like.

In the case of using the impact-type sphericalization apparatus as describe in (A) above, the spherical electrolytic manganese dioxide having an average circularity of 0.89 or more is provided. The impact-type sphericalization apparatus comprises: a cylindrical casing with a plurality of grooves formed on its inner peripheral surface; and an approximately cylindrical rotor with a plurality of grooves formed on its outer peripheral surface, the rotor being mounted rotatably around an axis thereof coinciding with an axis of the casing. The sphericalization method comprises the steps of: introducing electrolytic manganese dioxide particles in the bottom of the casing; guiding the electrolytic manganese dioxide particles to a processing portion formed between the inner peripheral surface of the casing and the outer peripheral surface of the rotor, by means of a vortex flow generated between the rotor and the casing by the rotation of the rotor; and sphericalizing electrolytic manganese dioxide particles guided to the processing portion as described above by the collisions of the electrolytic manganese dioxide particles against the inner peripheral surface of the casing and the outer peripheral surface of the rotor and the collisions of the electrolytic manganese dioxide particles with each other, while the electrolytic manganese dioxide particles are passing through the processing portion before discharged from the top of the casing.

In the case of using the impact-type sphericalization apparatus as described in (B) above for sphericalization of electrolytic manganese dioxide, the conditions for sphericalizing electrolytic manganese dioxide are preferably that the number of rotation of the dispersion rotor is 2000 to 4000 rpm, and the processing time of the electrolytic manganese dioxide is 1 to 20 minutes.

Further, in the forgoing range of the number of rotation of the dispersion rotor, a range of 3000 to 4000 rpm is particularly preferred, and 4000 rpm is more preferred. In the forgoing range of the processing time of the electrolytic manganese dioxide, a range of 1 to 10 minutes is particularly preferred, and 1 minute is more preferred.

In the impact-type sphericalization apparatus as describe in (B) above, the clearance between the outside container and the inside drum is preferably 1 to 10 mm. Further, it is preferable that friction surfaces against which the subject to be processed is rubbed in the space between the outside container and the inside drum are roughened. In this case, the surface roughness of the friction surfaces is preferably 1 to 5 mm in terms of ten-point average roughness (Rz, JIS B 0601: 2001)

The impact-type sphericalization apparatus as describe in (B) above is specifically exemplified by a multifunctional processing unit for particle design available from Hosokawa Micron Corporation under the trade name “FACULTY” (model number F-400), and the like.

In the case of using the impact-type sphericalization apparatus as describe in (B) above, the spherical electrolytic manganese dioxide having an average circularity of 0.89 or more is provided. The impact-type sphericalization apparatus comprises: a cylindrical outside container arranged such that a center axis thereof is along the vertical direction; a disc-shaped dispersion rotor mounted horizontally rotatably, vertically below the outside container; and an inside drum disposed in the outside container so as to be spaced apart from the inner wall surface of the outside container and from the dispersion rotor. The sphericalization method comprises the steps of: introducing electrolytic manganese dioxide particles upwardly into the space between the outside container and the inside drum; guiding the electrolytic manganese dioxide particles over the upper opening end of the inside drum, through the interior of the inside drum and to the lower opening end of the inside drum; and sphericalizing the electrolytic manganese dioxide particles guided to the lower opening end of the inside drum as described above by the collisions of the electrolytic manganese dioxide particles against the inner wall surface of the outside container, the collisions of the electrolytic manganese dioxide particles against the wall surfaces of a plurality of blocks provided so as to be spaced apart from one another on the peripheral upper surface of the dispersion rotor rotating horizontally, and the collisions of the electrolytic manganese dioxide particles with each other.

In the case of using the fluidized-bed jet mill as described in (C) above for sphericalization of electrolytic manganese dioxide, the conditions for sphericalizing electrolytic manganese dioxide are preferably that the pressure of the compressed air flow is 0.1 to 0.4 MPa, and the processing time of the electrolytic manganese dioxide is 1 to 20 minutes.

Further, in the forgoing range of the pressure of the compressed air flow, a range of 0.2 to 0.3 MPa is particularly preferred. In the forgoing range of the processing time of the electrolytic manganese dioxide, a range of 1 to 10 minutes is particularly preferred.

In the fluidized-bed jet mill as described in (C) above, the diameter of the tank is preferably 100 to 500 mm.

The fluidized-bed jet mill as described in (C) above is specifically exemplified by a fluidized-bed jet mill available from Hosokawa Micron Corporation under the trade name “Counter Jet Mill” (model number 100AFG), and the like.

In the case of using the fluidized-bed jet mill as described in (C) above, the spherical electrolytic manganese dioxide having an average circularity of 0.89 or more is provided. The fluidized-bed jet mill comprises: a bottomed approximately cylindrical tank; and a plurality of jet nozzles for supplying compressed air into the tank, the jet nozzles being disposed at the side of the bottom of the tank so as to be directed to the center of the tank. The sphericalization method comprises the steps of introducing electrolytic manganese dioxide particles into the bottom of the tank, and sphericalizing the electrolytic manganese dioxide particles thus introduced into the bottom of the tank by the collisions of the electrolytic manganese dioxide particles with each other caused by a flow of the compressed air supplied from each of the jet nozzles.

The loss on heating from 200 to 400° C. of the spherical electrolytic manganese dioxide thus obtained is preferably 2.5% by weight or more, more preferably 2.8% by weight or more, and most preferably in a range from 2.8 to 3.5% by weight.

The loss on heating, namely, the weight loss rate of the electrolytic manganese dioxide when heated in the temperature range of 200 to 400° C. is an index showing the content of combined water present in the interior of the electrolytic manganese dioxide. Here, the rate of decrease in weight of the spherical electrolytic manganese dioxide from when the measured temperature reaches 200° C. to when the measured temperature reaches 400° C. is measured, and the value thus obtained is referred to as the “loss on heating from 200 to 400° C.”.

When the loss on heating is 2.5% by weight or more, a sufficient amount of combined water is contained in the electrolytic manganese dioxide. As such, hydrogen ions can easily migrate through the solid phase of the electrolytic manganese dioxide. For this reason, the use of a spherical electrolytic manganese dioxide with such a large loss on heating can further improve the high-rate discharge characteristic of the battery.

The loss on heating from 200 to 400° C. of electrolytic manganese dioxide can be adjusted, for example, by the temperature of an electrolytic bath and the concentration of sulfuric acid in the production (electrolysis) of the electrolytic manganese dioxide.

Specifically, in order to adjust the loss on heating from 200 to 400° C. of electrolytic manganese dioxide to 2.5% by weight or more, the temperature of an electrolytic bath during the electrolysis is preferably set at 95° C. or lower, and more preferably set at 70 to 95° C. The concentration of sulfuric acid during the electrolysis is preferably 8 g/L or more, and more preferably 15 to 55 g/L.

By using a spherical electrolytic manganese dioxide having an optimized average circularity and an optimized content of combined water represented by the loss on heating as the positive electrode active material, irrespective of whether the discharge rate is high or low, it is possible to improve the battery capacity. In other words, it is possible to obtain a synergetic effect that combines an excellent filling property into the positive electrode, which is dependent on the average circularity of the manganese dioxide particles, and excellent high-rate discharge characteristics, which are dependent on the content of the combined water in the manganese dioxide particles.

In the above-described spherical electrolytic manganese dioxide, the total volume of particles having a particle size of 1 μm or more is preferably 40% by volume or more relative to the entire volume of the manganese dioxide particles, and more preferably 40 to 80% by volume relative to the entire volume.

When the total volume of particles having a particle size of 1 μm or more is 40% by volume or more relative to the entire volume of the manganese dioxide particles, and particularly preferably when 40 to 80% by volume, since the content ratio of fine particles having a particle size below 1 μm is relatively low, the filling property of the spherical electrolytic manganese dioxide into the positive electrode can be further improved. Moreover, this makes it possible to further improve the battery capacity.

When the total volume of particles having a particle size of 1 μm or more is 40% by volume or more relative to the entire volume of the manganese dioxide particles, since the electrolytic manganese dioxide having been subjected to sphericalization has a more uniform particle size, the gaps formed between the manganese dioxide particles in the electrode become more uniform. This allows for easy migration of the electrolyte, and consequently the polarization (concentration polarization) caused depending on the concentration distribution of the electrolyte in the interior of the battery is inhibited. As a result, an electrolytic manganese dioxide with excellent high-rate discharge characteristics can be provided.

In the above-described spherical electrolytic manganese dioxide, the ratio of the total volume of particles having a particle size of 1 μm or more can be adjusted by, for example, classifying the spherical electrolytic manganese dioxide particles.

The average particle size of the spherical electrolytic manganese dioxide is preferably 1 to 100 μm in terms of median diameter D₅₀ by volume. When the average particle size is within the forgoing range, the uniformity of particle size of the electrolytic manganese dioxide is maintained, and therefore it is possible to further improve the filling property of the spherical electrolytic manganese dioxide into the positive electrode as well as to more uniformly form the gap between the manganese dioxide particles in the electrode.

The spherical electrolytic manganese dioxide preferably includes polycrystalline particles.

Further, the spherical electrolytic manganese dioxide preferably has a high crystallinity. When the crystallinity of the manganese dioxide particle is low, a lot of micropores (mesopores) are present among the particles. The use of such manganese dioxide particles as the positive electrode active material involves a risk that the positive electrode may easily expand in the final stage of discharge. If the positive electrode expands, the supply of the electrolyte from the negative electrode and the separator is inhibited to increase the polarization in the positive electrode, and thus the discharge capacity may be reduced.

On the other hand, when the crystallinity of the manganese dioxide particle is high, the specific surface area thereof is normally small. It is preferable that the manganese dioxide particle has a small specific surface area, in view of suppressing the polarization in the positive electrode.

The specific surface area of the spherical electrolytic manganese dioxide is preferably 10 m²/g or more and 45 m²/g or less, as a value measured by BET method. By adjusting the specific surface area within the forgoing range, the discharge capacity of a battery including the above-described spherical electrolytic manganese dioxide as the positive electrode active material can be further increased. In the forgoing range of the specific surface area of the spherical electrolytic manganese dioxide, a range of 20 m²/g or more and 40 m²/g or less is particularly preferred.

The spherical electrolytic manganese dioxide, as described above, allows hydrogen ions to diffuse well through the solid phase thereof and has an excellent filling property into the positive electrode. As such, the above-described spherical electrolytic manganese dioxide is suitably applicable as a positive electrode active material for providing a high capacity alkaline primary battery with excellent high-rate discharge characteristics.

Moreover, having been produced by the production methods as described above, the above-described spherical electrolytic manganese dioxide can maintain its suitable particle size as the positive electrode active material for an alkaline primary battery without being pulverized excessively and, simultaneously, have a higher circularity.

Next, an alkaline primary battery including the above-described spherical electrolytic manganese dioxide is described.

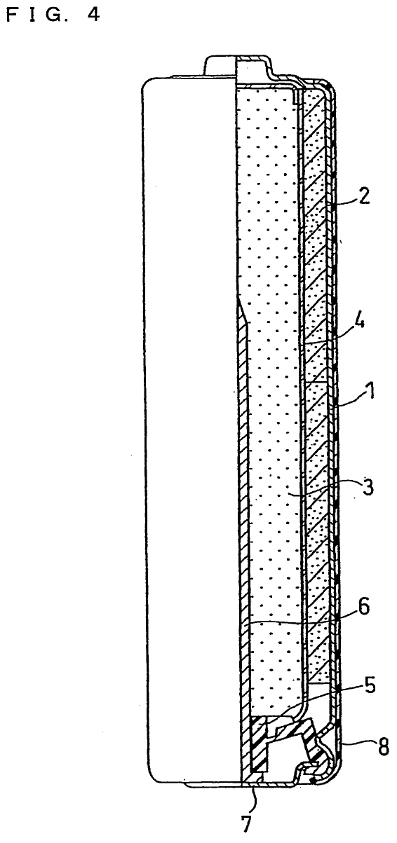

Referring to FIG. 4, the alkaline primary battery includes a positive electrode case 1, a positive electrode 2, a negative electrode 3, a separator 4 interposed between the positive electrode 2 and the negative electrode 3, and an electrolyte. The positive electrode 2 includes a positive electrode active material containing a spherical electrolytic manganese dioxide having an average circularity of 0.89 or more, a conductive agent, and the electrolyte.

The positive electrode case 1 also serves as a positive electrode terminal of the alkaline primary battery. This positive electrode case 1 is formed, for example, of a nickel-plated steel sheet. On the inner surface of the positive electrode case 1, a graphite coating film is formed. In the inside of the positive electrode case 1, pellets of positive electrode material mixture that have been molded into a cylindrical shape are placed and pressed with a pressing jig so as to be brought into close contact with the inner wall of the positive electrode case 1. In the inside of the cylindrical pellets of positive electrode material mixture (the positive electrode 2), the cylindrical separator 4 with one end closed (in the positive electrode terminal side) is disposed. A predetermined amount of electrolyte is injected into the separator 4. Further, the gelled negative electrode 3 is filled into the separator 4, and a negative electrode current collector 6 is inserted in the center of the negative electrode 3 from the other side (the opening end side of the positive electrode case 1). The negative electrode current collector 6 is electrically connected to a bottom plate (sealing plate) 7 also serving as a negative electrode terminal of the alkaline primary battery, the bottom plate closing the opening of the positive electrode case 1. Further, a resin gasket 5 is interposed between the opening end of the positive electrode case 1, and the negative electrode current collector 6 and the bottom plate 7. Finally, the outer surface of the positive electrode case 1 is covered with a jacket label 8.

The positive electrode active material contains the spherical electrolytic manganese dioxide having an average circularity of 0.89 or more as an essential component.

The positive electrode active material may further contain, for example, a nickel oxyhydroxide powder as an optional component. When the positive electrode active material contains the spherical electrolytic manganese dioxide having an average circularity of 0.89 or more as well as a nickel oxyhydroxide powder, the high-rate discharge characteristics and the battery capacity are further improved.

In the case where the spherical electrolytic manganese dioxide having an average circularity of 0.89 or more and a nickel oxyhydroxide powder are used in combination for the positive electrode active material, the weight ratio of the spherical electrolytic manganese dioxide to the nickel oxyhydroxide powder is preferably 80:20 to 10:90, and more preferably 80:20 to 50:50, in view of simultaneously achieving improved high-rate discharge characteristics and improved battery capacity. As long as the content ratio of the spherical electrolytic manganese dioxide in the positive electrode active material is 10% by weight or more, the effect of the present invention can be confirmed sufficiently.

Examples of the conductive agent include, for example, a graphite powder and the like.

Examples of the negative electrode include, for example, a gelled negative electrode containing a negative electrode active material, a gelling agent, and an electrolyte; and the like

Examples of the negative electrode active material include, for example, a zinc powder, a zinc alloy powder, and the like. The metal other than zinc contained in the zinc alloy powder is exemplified by, but not limited to, aluminum, bismuth, indium, and the like.

The negative electrode active material, although no particular limitation is imposed on its particle size, preferably contains, for example, a powder having a particle size of more than 75 μm and 425 μm or less in a ratio of 60 to 80% by weight relative to the entire negative electrode active material, and a powder having a particle size of 75 μm or less in a ratio of 20 to 40% by weight relative to the entire negative electrode active material.

Examples of the gelling agent include, for example, sodium polyacrylate and the like.

Examples of the separator include, for example, a non-woven fabric composed mainly of polyvinyl alcohol fiber and rayon fiber, and the like.

Examples of the electrolyte include, for example, an aqueous potassium hydroxide solution, an aqueous sodium hydroxide solution, and the like.

The foregoing alkaline primary battery, because of the inclusion of the above-described spherical electrolytic manganese dioxide as the positive electrode active material, exhibits high capacity and high-rate discharge characteristics.

Specifically, in the foregoing alkaline primary battery, when a cycle comprising the steps of discharging for 2 seconds under a load of 1600 mW and then discharging for 10 seconds under a load of 650 mW is repeated without intervals between the cycles, the number of cycles repeated until the discharge voltage reaches 0.6 V is 360 cycles or more, preferably 370 cycles or more, and more preferably 400 cycles or more.

Since the foregoing alkaline primary battery has high capacity and excellent high-rate discharge characteristics, it is suitably applicable, for example, for a small dry battery. As for the dimensions of the alkaline primary battery, although various sizes can be selected according to its application, a size of 10 to 20 mm in diameter and 25 to 70 mm in length as a cylindrical dry battery is particularly preferred. Examples of such a cylindrical dry battery includes, for example, cylindrical dry batteries of 4/3A size (diameter: 17 mm, length: 67 mm), A size (diameter: 17 mm, length: 50 mm), 4/5A size (diameter: 17 mm, length: 43 mm), 2/3A size (diameter: 17 mm, length: 29 mm), AA size (diameter: 14.5 mm, length: 51 mm), AAA size (diameter: 10.5 mm, length 45 mm), and the like, according to the designation specified by American National Standards Institute (ANSI). Above all, the foregoing alkaline primary battery is suitably applicable as an AA size cylindrical dry battery.

The foregoing alkaline primary battery exhibits high capacity and excellent high-rate discharge characteristics as described above. Moreover, even when the battery is a small battery such as an AA size battery, the battery demonstrates sufficient capacity and excellent high-rate discharge characteristics. As such, the foregoing alkaline primary battery is suitably applicable as, for example, a power supply for various digital devices.

### EXAMPLES

The present invention is described specifically below by way of examples, but the present invention is not limited to the following examples.

### Example 1

### (1) Synthesis of Manganese Dioxide by Electrolysis

To an electrolytic bath provided with a titanium (Ti) plate serving as an anode and a platinum foil serving as a cathode, an aqueous manganese sulfate solution serving as an electrolytic bath was injected, and manganese dioxide was deposited by electrolysis. The aqueous manganese sulfate solution used as the electrolytic bath was prepared by mixing manganese sulfate and sulfuric acid (15 g/L) such that the concentration of the manganese sulfate was 50 g/L. The conditions of electrolysis were as follows.

Temperature of electrolytic bath: 95° C.

Current density of anode: 10 mA/cm²

Electrolysis time: 18 hours

The deposit deposited by electrolysis was scraped from the Ti-plate and crushed into particles having an average particle size of 50 μm. To 1 g of the crushed matter thus obtained, 5 mL of ion-exchange water was added. Thereafter, while the crushed matter was being stirred, an aqueous 0.1 N sodium hydroxide solution was added dropwise thereto to effect neutralization, whereby a slurry was obtained. The neutralization for obtaining the slurry was performed until a pH of 6.0 was reached and maintained for 5 minutes or longer. The slurry thus obtained was filtrated and dried at 90° C. for 4 hours, thereby to give an electrolytic manganese dioxide powder. The observation of this powder under a scanning electron microscope (SEM) revealed that the particles were amorphous in shape.

### (2) Sphericalization

The electrolytic manganese dioxide powder (amorphous in shape) prepared in (1) above was subjected to sphericalization using a sphericalization system available from EARTH TECHNICA CO., LTD. under the trade name “Kryptron Orb” (model number CSHO). The “Kryptron Orb” is an impact-type sphericalization apparatus 10 (as shown in FIG. 1) as describe in (A) above. The conditions of sphericalization were as follows.

Number of rotation of rotor 13: 6000 rpm

Number of times of processing with impact-type sphericalization apparatus 10: Once

Flow rate of vortex flow: 4 mm³/s (with the use of air; under a temperature of 0° C. and a pressure of one atmosphere (gauge pressure))

Feeding rate of electrolytic manganese dioxide into casing 11: 20 kg/h

Processing amount (feeding amount of the electrolytic manganese dioxide): 1.6 kg

Processing time: 5 minutes

### (3) Measurement of Average Circularity

The average circularity of the spherical electrolytic manganese dioxide having been subjected to sphericalization as described in (2) above was measured.

The circularity of manganese dioxide particle was measured with a particle image analyzer (“FPIA-3000” available from SISMEX CORPORATION). Specifically, to 50 mg of the electrolytic manganese dioxide powder having been subjected to sphericalization, 0.5 g of 10% nonionic surfactant (“N-95” available from KAO CORPORATION) was added first, and then 50 g of distilled water was further added. The resultant mixture solution was stirred for 1 minute in a supersonic wave bath. Thereafter, 5 mL of the mixture solution was measured out with a pipette and fed into the particle image analyzer. The image of manganese dioxide particles that are allowed to pass through a flow cell in a wide and flat flow by the Flat Sheath Flow technology was captured with a CCD camera. At this time, the number of manganese dioxide particles to be passed through the center of the flow cell was controlled to 2000 or more.

Next, from the image captured with the CCD camera, the circularity of the individual manganese dioxide particle was determined. Specifically, the projection area of one of the manganese dioxide particles was determined from the captured image. The circumference length of a circle having the same area as that of the projection area was calculated. The circumference length of the circle was divided by the length of the contour of the manganese dioxide particle to determine a circularity. From the data of the circularity determined with respect to 3700 manganese dioxide particles, the arithmetic average was calculated. The value thus calculated was referred to as an average circularity of the electrolytic manganese dioxide.

### (4) Measurement of Loss on Heating from 200 to 400° C.

The loss on heating from 200 to 400° C. of the spherical electrolytic manganese dioxide having been subjected to sphericalization as described in (2) above was measured with a thermal analyzer (TG-DTA). As the thermal analyzer, “TAS300” available from Rigaku Corporation was used. From the measurement results, the rate of decrease in weight of the spherical electrolytic manganese dioxide from when the measured temperature reached 200° C. to when the measured temperature reached 400° C. was determined, and the value thus determined was referred to as the “loss on heating from 200 to 400° C.”. The conditions of measurement with TG-DTA were as follows.

Standard sample: Al₂O₃

Temperature raising condition: Room temperature to 500° C.

Temperature raising rate: 2° C./min

Measurement atmosphere: Air

Feeding rate of air: 100 mL/min

### (5) Measurement of Particle Size Distribution

The particle size distribution of the spherical electrolytic manganese dioxide having been subjected to sphericalization as described in (2) above was measured with a wet type laser diffraction particle size distribution analyzer (“MICROTRAC HRA 9320-X100” available from NIKKISO CO., LTD.). As a dispersion medium in the measurement, water was used. Prior to the measurement, the spherical electrolytic manganese dioxide powder was subjected to dispersion for 60 seconds with a homogenizer (40 W). The conditions of particle distribution measurement were as follows.

Flow rate of water: 40 mL/sec

Measurement time: 30 seconds

The particle size distribution was measured two times in total. The measured values were averaged.

On the basis of the measurement results of the particle size distribution, the volume distribution of the manganese dioxide particles was calculated. In the calculation of volume distribution, the number of channels in measurement (the number of segments in particle size distribution) was assumed to be 100, and the relative refraction index of the electrolytic manganese dioxide was assumed to be 2.2. From the volume distribution thus obtained, the content ratio of manganese dioxide particles having a particle size of 1 μm or more and the average particle size of the manganese dioxide particles were calculated.

### (6) Formation of Pellet of Positive Electrode Material Mixture

The spherical electrolytic manganese dioxide having been subjected to sphericalization as described in (2) above and graphite were mixed in a weight ratio of 95:5, to give a powdery positive electrode material mixture. To 100 parts by weight of the positive electrode material mixture powder thus obtained, 1.3 parts by weight of electrolyte was added and stirred with a mixer so as to be uniformly mixed. As the electrolyte, an aqueous 39% by weight potassium hydroxide solution was used.

Subsequently, the resultant mixture was granulated and pulverized into particles having a uniform particle size using a roller compactor. Thereafter, the resultant particulate matter was compression-molded to give a pellet of positive electrode material mixture.

### (7) Preparation of Negative Electrode

A zinc powder serving as the negative electrode active material, sodium polyacrylate serving as the gelling agent, indium hydroxide (In(OH)₃), and an electrolyte (an aqueous 33% by weight potassium hydroxide solution) were mixed in a weight ratio of 65.17:0.75:0.02:33.94, whereby a gelled negative electrode was prepared.

### (8) Fabrication of Alkaline Primary Battery

As an alkaline primary battery including the spherical electrolytic manganese dioxide having been subjected to sphericalization as described in (2) above, the alkaline primary battery as shown in FIG. 4 was fabricated.

As the positive electrode case 1, a case made of a nickel-plated steel sheet having a graphite coating film on the inner surface thereof was used. The case was of a cylindrical shape having a diameter of 14.5 mm and a length of 51 mm, one end of which is closed. The positive electrode case 1 is equivalent to a case for an AA size battery. Subsequently, in the inside of the positive electrode case 1, a plurality of the pellets of positive electrode material mixture 2 obtained in (6) above were placed and remolded with a pressing jig, so that layers of positive electrode material mixture 2 having a hollow cylindrical shape was formed.

In the center of the layers of positive electrode material mixture 2, the cylindrical separator 4 with one end closed (in the positive electrode terminal side) made of a non-woven fabric composed mainly of polyvinyl alcohol fiber and rayon fiber was disposed. The electrolyte (the aqueous 33% by weight potassium hydroxide solution) was injected into the separator 4.

After the passage of a predetermined time, the gelled negative electrode 3 as prepared in (7) above was filled into the separator 4, and then the negative electrode current collector 6 was inserted in the center of the gelled negative electrode 3.

Subsequently, the opening of the positive electrode case 1 was sealed with the resin gasket 5 and the bottom plate 7. Finally, the outer surface of the positive electrode case 1 was covered with the jacket label 8, whereby an AA size alkaline primary battery was obtained.

### (9) Evaluation of Battery Characteristics

The alkaline primary battery thus obtained was discharged under the following conditions of discharge.

Conditions of discharge: A cycle comprising the steps of discharging for 2 seconds under a load of 1600 mW and then discharging for 10 seconds under a load of 650 mW was repeated without intervals between the cycles. The number of cycles repeated until the discharge voltage reached 0.6 V was measured to evaluate the battery characteristics.

### Example 2

A spherical electrolytic manganese dioxide was prepared in the same manner as in Example 1 except that the concentration of the sulfuric acid in the electrolytic bath was 20 g/L, and the number of rotation of the rotor in the sphericalization was 7000 rpm.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 3

A spherical electrolytic manganese dioxide was prepared in the same manner as in Example 1 except that the concentration of the sulfuric acid in the electrolytic bath was 25 g/L, and the number of rotation of the rotor in the sphericalization was 8000 rpm.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 4

A spherical electrolytic manganese dioxide was prepared in the same manner as in Example 1 except that the concentration of the sulfuric acid in the electrolytic bath was 45 g/L, and the number of rotation of the rotor in the sphericalization was 9000 rpm.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 5

A spherical electrolytic manganese dioxide was prepared in the same manner as in Example 1 except that the concentration of the sulfuric acid in the electrolytic bath was 40 g/L, the number of rotation of the rotor in the sphericalization was 9000 rpm, and the number of times of feeding the electrolytic manganese dioxide into the casing was two times.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 6

A spherical electrolytic manganese dioxide was prepared in the same manner as in Example 1 except that the concentration of the sulfuric acid in the electrolytic bath was 50 g/L, and the number of rotation of the rotor in the sphericalization was 10,000 rpm.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 7

A spherical electrolytic manganese dioxide was prepared in the same manner as in Example 1 except that the concentration of the sulfuric acid in the electrolytic bath was 45 g/L, the number of rotation of the rotor in the sphericalization was 10,000 rpm, and the number of times of feeding the sample was two times.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 8

A spherical electrolytic manganese dioxide was prepared in the same manner as in Example 1 except that the concentration of the sulfuric acid in the electrolytic bath was 8 g/L.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### COMPARATIVE EXAMPLE 1

A spherical electrolytic manganese dioxide was prepared in the same manner as in Example 1 except that the concentration of the sulfuric acid in the electrolytic bath was 30 g/L, and a ball mill (a pot mill rotator “ANZ-50S” available from NITTO KAGAKU Co., Ltd.) was used in the sphericalization. The conditions of sphericalization were as follows.

Milling container: Polypropylene container with internal volume of 100 mL

Number of rotation of milling container: 65 rpm

Processing time: 12 hours

Ball contained in milling container: Zirconia ball of 1 mm in diameter

Total amount of balls: 60 g

Amount of electrolytic manganese dioxide contained in milling container: 20 g

An alkaline primary battery was fabricated in the same manner as in Example 1 except that the electrolytic manganese dioxide thus obtained was used as the positive electrode active material. With respect to the alkaline primary battery thus obtained, the number of cycles was measured in the same manner as in Example 1 to evaluate the battery characteristics.

### COMPARATIVE EXAMPLE 2

A powder of electrolytic manganese dioxide was prepared in the same manner as in “(1) Synthesis of manganese dioxide by electrolysis” in Example 1 except that the concentration of the sulfuric acid in the electrolytic bath was 45 g/L.

An alkaline primary battery was fabricated in the same manner as in Example 1 except that the powder of electrolytic manganese dioxide thus obtained was used as it was (without being subjected to sphericalization) as the positive electrode active material. With respect to the alkaline primary battery thus obtained, the number of cycles was measured in the same manner as in Example 1 to evaluate the battery characteristics.

Comparison of Results of Battery Characteristic

### Evaluation

Table 1 shows the concentration of sulfuric acid in the electrolytic bath and the conditions of sphericalization in Examples 1 to 8 and Comparative Examples 1 and 2.

[Table 1]

In Table 1, the values in the column “Concentration of H₂SO₄” are of the “concentration of the sulfuric acid in the electrolytic bath”. The column “Processing Apparatus” describes the “apparatus for use in the sphericalization”. The values in the column “Number of Rotation” are of the “number of rotation of the rotor” in the sphericalization (in Comparative Example 1, the “number of rotation of the milling container”). The column “Condition of Processing” describes the “number of times of processing with an impact-type sphericalization apparatus” (in Comparative Example 1, the “processing time”).

Table 2 shows evaluation results of the battery characteristics in Examples 1 to 8 and Comparative Examples 1 and 2.

[Table 2]

In Table 2, the values in the column “Average Circularity” are of the “average circularity” of the spherical electrolytic manganese dioxide. The values in the column “Loss on Heating” are of the “loss on heating from 200 to 400° C.” of the spherical electrolytic manganese dioxide. The values in the column “Content of Particle” are of the “content ratio of manganese dioxide particles having a particle size of 1 μm or more” relative to the entire volume of the spherical electrolytic manganese dioxide. The values in the column “Number of cycles” are of the “number of cycles repeated until the discharge voltage reaches 0.6 V”.

As shown in Table 2, in the alkaline primary batteries of Comparative Examples 1 and 2, the number of cycles repeated until the discharge voltage reached 0.6 V (hereinafter simply referred to as “number of cycles”) was less than 345 cycles.

Conversely, in the alkaline primary batteries of Examples 1 to 8, the number of cycles was 360 cycles of more. Among these, in Examples 1 to 7 in which the loss on heating was 2.5% by weight or more, the number of cycles was 370 cycles or more.

The foregoing indicates that when the electrolytic manganese dioxide used as the positive electrode active material has an average circularity of 0.89 or more and a loss on heating from 200 to 400° C. of 2.5% by weight or more, a high capacity alkaline primary battery with excellent high-rate discharge characteristics can be provided.

Further, in the batteries of Examples 3 to 7, the number of cycles was 400 cycles or more. Therefore, it is more preferable that the electrolytic manganese dioxide has an average circularity of 0.92 or more and a loss on heating from 200 to 400° C. of 2.8% by weight or more.

In addition, with respect to the electrolytic manganese dioxide prepared in Comparative Example 1, the particle size distribution was measured before and after the sphericalization with the ball mill in the same manner as in Example 1. The results show that the peak of the particle size distribution of the electrolytic manganese dioxide after the sphericalization with the ball mill was shifted to the small particle size side as compared with that of the electrolytic manganese dioxide before the sphericalization with the ball mill (i.e., the volume distribution of particles with large particle size was decreased, and the volume distribution of particle with small particle size was increased). This indicates that in Comparative Example 1, the particles were cracked in the sphericalization of the electrolytic manganese dioxide.

### Example 9

The electrolytic manganese dioxide powder (amorphous in shape) prepared in the same manner as in “(1) Synthesis of manganese dioxide by electrolysis” in Example 1 was subjected to sphericalization using a fluidized-bed jet mill available from Hosokawa Micron Corporation under the trade name “Counter Jet Mill” (model number 100AFG). This “Counter Jet Mill” is a fluidized-bed jet mill 37 (as shown in FIG. 3) as described in (C). The conditions of sphericalization were as follows.

Pressure of flow of compressed air: 0.2 MPa

Processing time of electrolytic manganese dioxide: 1 minute

Diameter of tank 38: about 100 mm

With respect to the spherical electrolytic manganese dioxide having been subjected to sphericalization with the fluidized-bed jet mill, the average circularity, the loss on heating from 200 to 400° C., and the particle size distribution were measured in the same manner as in Example 1.

An alkaline primary battery was fabricated in the same manner as in Example 1 except that the spherical electrolytic manganese dioxide having been subjected to sphericalization with the fluidized-bed jet mill was used as the positive electrode active material. With respect to the alkaline primary battery thus obtained, the number of cycles was measured in the same manner as in Example 1 to evaluate the battery characteristics.

### Example 10

A spherical electrolytic manganese dioxide was prepared in the same manner as in Example 9 except that the concentration of the sulfuric acid in the electrolytic bath was 40 g/L, and the processing time in the sphericalization was 3 minutes.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 11

A spherical electrolytic manganese dioxide was prepared in the same manner as in Example 9 except that the concentration of the sulfuric acid in the electrolytic bath was 45 g/L, and the processing time in the sphericalization was 10 minutes.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 12

A spherical electrolytic manganese dioxide was prepared in the same manner as in Example 9 except that the concentration of the sulfuric acid in the electrolytic bath was 40 g/L, and the pressure of the flow of compressed air in the sphericalization was 0.3 MPa.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 13

A spherical electrolytic manganese dioxide was prepared in the same manner as in Example 9 except that the concentration of the sulfuric acid in the electrolytic bath was 55 g/L, and the pressure of the flow of compressed air in the sphericalization was 0.3 MPa.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 14

A spherical electrolytic manganese dioxide was prepared in the same manner as in Example 9 except that the concentration of the sulfuric acid in the electrolytic bath was 30 g/L, the pressure of the flow of compressed air in the sphericalization was 0.3 MPa, and the processing time was 5 minutes.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

### Example 15

A spherical electrolytic manganese dioxide was prepared in the same manner as in Example 9 except that the concentration of the sulfuric acid in the electrolytic bath was 40 g/L, the pressure of the flow of compressed air in the sphericalization was 0.3 MPa, and the processing time was 10 minutes.

An alkaline primary battery was fabricated in the same manner as in Example 1 except that the spherical electrolytic manganese dioxide thus obtained was used as the positive electrode active material. With respect to the alkaline primary battery thus obtained, the number of cycles was measured in the same manner as in Example 1 to evaluate the battery characteristics.

Comparison of Results of Battery Characteristic Evaluation

Table 3 shows the concentration of sulfuric acid in the electrolytic bath and the conditions of sphericalization in Examples 9 to 15 together with those in Comparative Examples 1 and 2.

[Table 3]

In Table 3, the definitions of “Concentration of H₂SO₄”, “Processing Apparatus”, “Number of Rotation”, and “Condition of Processing” are the same as in Table 1. The values in the column “Pressure of Airflow” are of the “pressure of the flow of compressed air”.

Table 4 shows evaluation results of the battery characteristics in Examples 9 to 15 together with those in Comparative Examples 1 and 2.

[Table 4]

In Table 4, the definitions of “Average Circularity”, “Loss on Heating”, “Content of Particles”, and “Number of Cycles” are the same as in Table 2.

As shown in Table 4, in the alkaline primary batteries of Examples 9 to 15, the number of cycles of each battery was as large as 400 cycles or more. This indicates that when the spherical electrolytic manganese dioxide as prepared in Examples 9 to 15 is used, a high capacity alkaline primary battery with excellent high-rate discharge characteristics can be provided.

In particular, in Examples 10 to 15 in which the total volume of particles having a particle size of 1 μm or more was 40% or more relative to the entire volume, the number of cycles was further increased to 410 cycles or more. In view of these results, it is preferable that the total volume of spherical electrolytic manganese dioxide having a particle size of 1 μm or more is 40% by volume or more relative to the entire manganese dioxide particles.

Among these, in the alkaline primary batteries of Examples 10 to 13, the number of cycles was 420 cycles or more. Therefore, it is more preferable that the total volume of spherical electrolytic manganese dioxide having a particle size of 1 μm or more is 40 to 80% by volume or more relative to the entire manganese dioxide particles.

### Example 16

An electrolytic manganese dioxide powder (amorphous in shape) was prepared in the same manner as in “(1) Synthesis of manganese dioxide by electrolysis” in Example 1 except that the concentration of the sulfuric acid in the electrolytic bath was 45 g/L.

The electrolytic manganese dioxide powder thus prepared was subjected to sphericalization using a multifunctional processing unit for particle design available from Hosokawa Micron Corporation under the trade name “FACULTY” (model number F-400). This “FACULTY” is an impact-type sphericalization apparatus 22 (as shown in FIG. 2) as describe in (B). The conditions of sphericalization were as follows.

Number of rotation of dispersing roller 25: 4000 rpm

Processing time of electrolytic manganese dioxide: 1 minute

With respect to the spherical electrolytic manganese dioxide having been subjected to sphericalization with the fluidized-bed jet mill, the average circularity, the loss on heating from 200 to 400° C., and the particle size distribution were measured in the same manner as in (3) to (5) in Example 1.

An alkaline primary battery was fabricated in the same manner as in Example 1 except that the spherical electrolytic manganese dioxide having been subjected to sphericalization with the fluidized-bed jet mill was used as the positive electrode active material. With respect to the alkaline primary battery thus obtained, the number of cycles was measured in the same manner as in Example 1 to evaluate the battery characteristics.

Table 5 shows the conditions of sphericalization in Example 16 together with those in Comparative Examples 1 and 2.

[Table 5]

In Table 5, the definitions of “Concentration of H₂SO₄”, “Processing Apparatus”, “Number of Rotation”, and “Condition of Processing” are the same as in Table 1.

Table 6 shows evaluation results of the battery characteristics in Example 16 together with those in Comparative Examples 1 and 2.

[Table 6]

In Table 6, the definitions of “Average Circularity”, “Loss on Heating”, “Content of Particles”, and “Number of Cycles” are the same as in Table 2.

As shown in Table 6, in the alkaline primary battery of Example 16, the number of cycles was as large as 438 cycles. This indicates that when the spherical electrolytic manganese dioxide as prepared in Example 16 is used, a high capacity alkaline primary battery with excellent high-rate discharge characteristics can be provided.

As described above, the present invention can provide improvements in capacity as well as high-rate discharge characteristics in alkaline primary batteries. The present invention can exert excellent effects also in an alkaline primary battery including a positive electrode containing nickel oxyhydroxide.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A spherical electrolytic manganese dioxide having an average circularity of 0.89 or more.

2. The spherical electrolytic manganese dioxide in accordance with claim 1, wherein the loss on heating from 200° C. to 400° C. is 2.5% by weight or more.

3. The spherical electrolytic manganese dioxide in accordance with claim 1, wherein the total volume of particles having a particle size of 1 μm or more is 40% or more relative to the entire volume.

4. The spherical electrolytic manganese dioxide in accordance with claim 1, wherein the average particle size is 1 to 100 μm.

5. The spherical electrolytic manganese dioxide in accordance with claim 1, wherein the specific surface area is 10 m²/g or more and 45 m²/g or less.

6. An alkaline primary battery comprising: a positive electrode including a positive electrode active material; a negative electrode; a separator interposed between said positive electrode and said negative electrode; an electrolyte; and a case having a space for housing said positive electrode, said negative electrode, said separator, and said electrolyte, wherein said positive electrode active material contains a spherical electrolytic manganese dioxide having an average circularity of 0.89 or more.

7. The alkaline primary battery in accordance with claim 6, wherein the loss on heating from 200° C. to 400° C. of said spherical electrolytic manganese dioxide is 2.5% by weight or more.

8. The alkaline primary battery in accordance with claim 6, wherein in said spherical electrolytic manganese dioxide, the total volume of particles having a particle size of 1 μm or more is 40% or more relative to the entire volume of said spherical electrolytic manganese dioxide.

9. The alkaline primary battery in accordance with claim 6, wherein when a cycle comprising the steps of discharging for 2 seconds under a load of 1600 mW and then discharging for 10 seconds under a load of 650 mW is repeated without intervals between the cycles, the number of cycles repeated until the discharge voltage reaches 0.6 V is 360 cycles or more.

10. The alkaline primary battery in accordance with claim 6, wherein said case is of a cylindrical shape and has a diameter of 10 to 20 mm and a length of 25 to 70 mm.

11. The alkaline primary battery in accordance with claim 10, wherein said case has a size equivalent to an AA size dry battery.

12. A method for producing a spherical electrolytic manganese dioxide comprising:
a deposition step of depositing manganese dioxide by electrolysis of a solution containing manganese; and
a sphericalization step of sphericalizing the manganese dioxide deposited in said deposition step, with the use of an impact-type sphericalization apparatus comprising: a cylindrical casing with a plurality of grooves formed on its inner peripheral surface; and an approximately cylindrical rotor with a plurality of grooves formed on its outer peripheral surface, the rotor being mounted rotatably around an axis thereof coinciding with an axis of said casing, wherein subject particles to be processed introduced into the bottom of said casing are guided into a processing portion formed between the inner peripheral surface of said casing and the outer peripheral surface of said rotor, by means of a vortex flow generated between said rotor and said casing by the rotation of said rotor; and the subject particles are sphericalized by the collisions of the subject particles against the inner peripheral surface of said casing and the outer peripheral surface of said rotor and the collisions of the subject particles with each other, while passing through said processing portion before being discharged from the top of said casing.

13. The method for producing a spherical electrolytic manganese dioxide in accordance with claim 12, wherein in said sphericalization step, the feeing rate of the manganese dioxide deposited in said deposition step into said casing is 20 to 60 kg/h, the number of rotation of said rotor is 5,000 to 13,000 rpm, and the number of times of processing with said impact-type sphericalization apparatus is once to three times.

14. A method for producing a spherical electrolytic manganese dioxide comprising:
a deposition step of depositing manganese dioxide by electrolysis of a solution containing manganese; and
a sphericalization step of sphericalizing the manganese dioxide deposited in said deposition step, with the use of an impact-type sphericalization apparatus comprising: a cylindrical outside container arranged such that a center axis thereof is along the vertical direction; a disc-shaped dispersion rotor mounted horizontally rotatably, vertically below said outside container; and an inside drum disposed in said outside container so as to be spaced apart from the inner wall surface of said outside container and from said dispersion rotor, wherein subject particles to be processed are introduced upwardly into the space between said outside container and said inside drum and guided over the upper opening end of said inside drum, through the interior of said inside drum and to the lower opening end of said inside drum; and the subject particles are sphericalized by the collisions of the subject particles against the inner wall surface of said outside container, the collisions of the subject particles against the wall surfaces of a plurality of blocks provided so as to be spaced apart from one another on the peripheral upper surface of said dispersion rotor rotating horizontally, and the collisions of the subject particles with each other.

15. The method for producing a spherical electrolytic manganese dioxide in accordance with claim 14, wherein in said sphericalization step, the number of rotation of said dispersion rotor is 2000 to 4000 rpm, and the processing time of the manganese dioxide deposited in said deposition process is 1 to 20 minutes.

16. A method for producing a spherical electrolytic manganese dioxide comprising:
a deposition step of depositing manganese dioxide by electrolysis of a solution containing manganese; and
a sphericalization step of sphericalizing the manganese dioxide deposited in said deposition step, with the use of a fluidized-bed jet mill comprising: a bottomed approximately cylindrical tank; and a plurality of jet nozzles for supplying compressed air into said tank, the jet nozzles being disposed at the side of the bottom of said tank so as to be directed to the center of said tank, wherein subject particles to be processed are sphericalized by the collisions of the subject particles with each other caused by a flow of the compressed air supplied from each of said jet nozzles.

17. The method for producing a spherical electrolytic manganese dioxide in accordance with claim 16, wherein in said sphericalization step, the pressure of the flow of the compressed air is 0.1 to 0.4 MPa, and the processing time of the manganese dioxide deposited in said deposition process is 1 to 20 minutes.
